(19) United States
(12) Patent Application Publication
(10) Pub. No.: US 2004/0207768 A1
(43) Pub. Date: Oct. 21, 2004

(54) Electron-beam controlled micromirror (ECM) projection display system

(76) Inventor: Yin Liu, Fremont, CA (US)

Correspondence Address: Yin Liu, 37466 Stonewood Dr., Fremont, CA, 94536, US

(21) Appl. No.: 10/822,124

(22) Filed: Apr. 10, 2004

Related U.S. Application Data
(60) Provisional application No. 60/463,440, filed on Apr. 15, 2003.

(51) Int. Cl. H04N 5/64

(52) U.S. Cl. 348/744

(57) ABSTRACT

This invention provides a projection system with an Electron-beam Controlled Micromirror (ECM) display system. The ECM device overcomes the problems of high cost, and low yields associated with similar techniques. The ECM device is ideally used in high definition projection display applications. The ECM consists of five layers, i.e., a transparent substrate, a transparent conducting film, a micromirror array, an insulation membrane, and a patterned collector grid that is attached on the membrane.

This invention is converted from the Provisional Patent, “Reflection Micro-mirror Device for Projection Display”, No. 60/463440, application date Apr. 15, 2003.

### CROSS REFERENCE TO RELATED APPLICATIONS

U.S. Patent Documents

| | | | |
|---|---|---|---|
| 3678196 | Jul., 1972 | Roth | 178/7 |
| 3886310 | May 1975 | Guldbergetal. | 178/7 |
| 3896338 | July 1975 | Nathansonetal. | 315/373 |
| 4229732 | October 1980 | Hartstein et al. | 340/378 |
| 4387964 | June 1983 | Arrazola et al. | 350/331 |
| 4592628 | June 1986 | Altman et al. | 350/486 |
| 4698602 | October 1987 | Armitage | 332/7 |
| 4744636 | May 1988 | Haven et al. | 350/331 |
| 4784883 | November 1988 | Chitwood et al. | 428/1 |
| 4786149 | November 1988 | Hoenigetal. | 350/356 |
| 4826293 | May 1989 | Grinbergetal. | 350/331 |
| 4884874 | December 1989 | Buzak et al. | 350/336 |
| 5196767 | March 1993 | Leard et al. | 315/349 |
| 5231388 | July 1993 | Stoltz | 340/783 |
| 5287215 | February 1994 | Warde et al. | 359/293 |
| 5416514 | May 1995 | Janssen et al. | 348/196 |
| 5442414 | August 1995 | Janssen et al. | 353/98 |
| 5444566 | August 1995 | Gale et al. | 359/291 |
| 5447110 | September 1995 | Smith et al. | 315/169 |
| 5448314 | September 1995 | Heimbuch et al. | 348/743 |
| 5452024 | September 1995 | Sampsell | 348/755 |
| 5471341 | November 1995 | Warde et al. | 359/293 |
| 5493439 | February 1996 | Engle | 359/292 |
| 5504614 | April 1996 | Webb et al. | 359/223 |
| 5504629 | April 1996 | Lim | 359/850 |
| 5508738 | April 1996 | Janssen et al. | 348/196 |
| 5552925 | September 1996 | Worley | 359/230 |
| 5557177 | September 1996 | Engle | 315/366 |
| 5567334 | October 1996 | Baker et al. | 216/24 |
| 5579151 | November 1996 | Cho | 359/291 |
| 5610478 | March 1997 | Kato et al. | 315/169 |
| 5612753 | March 1997 | Poradish et al. | 348/743 |
| 5631782 | May 1997 | Smith et al. | 359/871 |
| 5636070 | June 1997 | Ji et al. | 359/855 |
| 5650881 | July 1997 | Hornbeck | 359/871 |
| 5669687 | September 1997 | Yang | 353/98 |
| 5677784 | October 1997 | Harris | 359/290 |
| 5689278 | November 1997 | Barker et al. | 345/74 |
| 5706061 | January 1998 | Marshall et al. | 348/743 |
| 5768009 | June 1998 | Little | 359/293 |
| 5774196 | June 1998 | Marshall | 348/743 |
| 5822110 | October 1998 | Dabbaj | 359/293 |
| 6,031,657 | February 2000 | Robinson et al. | 359/293 |

Other Reference:

Jack Mason, et al., “MEMS Micromirrors Reflecting the Big Picture in Home Theater”, Small Times Correspondent, Aug. 13, 2002.

C. C. Freudenrich, “How Projection Television Works”, http://www.howstuffworks.com.

J. A. van Raalte, “A New Schlieren Light Valve for Television Projection”, Applied Optics Vol. 9, No. 10, (October 1970), p. 2225.

Sang-Gook Kim, et al., “Actuated Mirror Array-A New Chip-based Display Device for the Large Screen Display,” SID Asia Display 1998.

R. Thomas et al., “The Mirror-Matrix Tube: A Novel Light Valve for Projection Displays,” ED-22 IEEE Tran. Elec. Dev. 765 (1975).

K. Petersen, “Silicon as a Mechanical Material”, Proceedings of the IEEE, 70 [5], 420-457, (1982).

S. T. deZwart et al., “Basic Principles of a New Thin Flat CRT,” SID Digest, pp. 239-242; 1997.

B. Chalamala et al., “FED up with Fat Tubes,” IEEE Spectrum, vol. 35, No. 4, pp. 41-51; April 1998.

S. Newman, et al., “Development of 5.1 Inch Field Emission Display,” Motorola Flat Panel Display Division, SID 1998.

C. J. Spindt et al., “Thin CRT.TM. Flat-Panel-Display Construction and Operating Characteristics,” SID Digest, pp. 99-102; 1998.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

This invention relates to projection displays and more specifically to an electron beam controlled reflective mirror projection display.

2. Description of the Related Art

The digital projector display market, including business projectors, televisions, and portable displays, has been growing continuously, and reached the size of ˜$4 billion in 2002. The key performance criteria for displays are brightness, contrast ratio, resolution, uniformity, and optical efficiency. The market for low cost, high brightness projection display is expected to grow at a rate of 120% until 2005. In 2005, the estimated market size is ˜6 million units for home projectors only, about 60 times of the market size in 2001 (98,000 units).

The current projectors rely on two general approaches, i.e., transmittive and reflective. In transmittive projectors, light passes through the image-forming element, e.g., cathode ray tube (CRT), or liquid crystal display (LCD) panel. In reflective projectors, image-forming element, e.g., MEMS micromirror element, bounces light off. In both types of projectors, a set of lens collects the image from the image-forming element, magnifies the image and focuses it onto a screen. Reflective projectors usually provide higher brightness and contrast than transmittive projectors.

Three types of display elements dominate today's digital projector market, i.e., MEMS displays, CRT displays, and LCD. Among them, MEMS displays are becoming a major factor in the market, because they offer higher brightness and contrast than CRT and LCD. Currently the major MEMS-based display technology is the Digital Micromirror Device (DMD) at the heart of the Digital Light Processing (DLP) system from Texas Instruments Inc. (TI). The DMD is a light valve, which operates in a bistable mode with a pulse-code modulated grey scale. The device includes an integrated CMOS SRAM structure under each element. DMD devices are very expensive (˜$500/each). Rear-projection televisions built around DMD/DLP technology cost between $4,000 and $10,000 in 2003.

Traditional CRT and LCD displays are much cheaper. The current market price of rear projection TV made from CRT/LCD technique is ˜⅓ of those made form DLP technique. But both CRT and LCD displays suffer from low light intensity and poor contrast.

Some reflective projection displays use electrostatically-actuated light modulators in which a beam of light is directed towards a light valve target, e.g., an array of micromirrors. The micromirrors response to a video addressing signal, imparts a modulation onto the light beam in proportion to the amplitude of the deflection of the individual reflective micromirrors. The amplitude or phase modulated beam is then passed through projection optics to form the image. In fact, DMD uses the same optical technique to make images.

There are several approaches to operate micromirrors. The most common approach in past two decades is using electrostatic to operate micromirrors. In this approach, the array of micromirrors produces attractive electrostatic forces between the underlying substrate and the individual mirrors that pull them inward toward the substrate. One micromirror corresponds to one display pixel. The amplitude of micromirror deflection corresponds to the pixel intensity in the video signal. The optical performance of the light modulator is closely tied to deflection range, electrostatic instability, micromirror size and array size.

In this approach, deflection range of micromirrors is strictly limited by the spacing of the array of micromirrors above the substrate. Generally, only about one-third of the gap can be usefully employed due to problems of electrostatic instability. The attractive forces tend to overwhelm the restoring spring force of the micromirror, causing the micromirror to snap all the way to the base electrode (this problem is commonly referred to as pull-in or snap-over). Once the element snaps over, it remains stuck to the substrate due to the Van der Waals forces. The useful range can be extended to about four-fifths of the gap by using a control electrode underneath the element whose diagonal is about 60% of the length of the micromirror's diagonal. However, this increases the voltage required to achieve the same amount of deflection.

In the early 1970s, Westinghouse Electric Corporation used the above technique to develop an electron gun addressed cantilever beam deformable mirror device for use in Schlieren projection display. The Westinghouse imager contains a vacuum cell, an electron gun, and a micromirror array. The device is fabricated by growing a thermal SiO₂ layer on a Si-on-sapphire substrate. The oxide is patterned in a cloverleaf array of four centrally joined cantilever beams. The Si is wet-etched isotopically until the oxide is undercut, leaving four oxide cantilever beams within each pixel supported by a central Si support post. The cloverleaf array is then metallized with Al for reflectivity. The cantilever beams and Al coating form micromirrors. The Al deposited on the sapphire substrate forms a reference grid electrode near the edges of the mirrors that is held at a d.c. bias. A field mesh is supported above the mirrors to collect any secondary electrons that are emitted from the mirrors in response to the incident primary electrons.

The device is addressed by a low energy scanning electron beam (e-beam) that deposits a charge pattern on the micromirror array, causing micromirrors to be deformed toward the reference grid electrodes on the substrate by electrostatic actuation. Erasure is achieved by holding the deposited charge on the mirror throughout the frame time, and then raising the target voltage to equal the field mesh potential while flooding the tube with low energy electrons to simultaneously erase all of the mirrors. This approach increases the modulator's contrast ratio but produces “flicker”, which is unacceptable in video applications.

The DMD from TI Inc. employs a torsional micromirror that rocks back-and-forth between binary positions with the tips of the mirror being pulled down to the base electrodes. The operation mode of DMD is called time division multiplexing (TDM), which is created by rapidly rocking the mirror back-and-forth between its two positions to establish different gray-levels. The electronics for implementing a TDM addressing scheme are much more complex and expensive than those required for analog modulation. The fabrication of DMD requires a complex CMOS process. Unlike a Schlieren system, the light reflected from the DMD is magnified by a projection lens for image viewing.

Because of the high cost of CMOS process per unit area, the DMD devices are made fairly small, 1.3″, which contributes to poor efficiency from the effects of geometrical extent, or “etendue.” This loss is due to the deficiency in collecting all the light from the source, which is related to size of an arc lamp with respect to the size of the imager. Generally, small aperture imagers do not collect light efficiently. Because of the various losses, less than 3% of the light energy reaches the screen in a typical DMD projector. The rest dissipates in heat.

In late 1990, MEMSolutions Inc. developed a CRT Charge Controlled Mirror (CCM) Display system that incorporated a large aperture reflective imager (˜2″), into a Schlieren optical system. The large aperture imager enables the use of arc lamps with larger source sizes, which increases lifetime and reduces cost.

The structure of MEMSolutions' CCM imager is similar to Westinghouse design. The imager includes a thin insulating membrane that is inserted into a vacuum cell to decouple the addressing e-beam from a micromirror array held at reference potential. The membrane is just thick enough to stop the incident electrons from penetrating through to the mirrors but is thin enough that the fringing fields are minimized and do not affect resolution. The membrane is supported by an array of insulating posts to withstand the applied electric field due to the induced charge pattern. Decoupling the micromirrors from the e-beam allows mirrors to be thinner, which in turn reduces the micromirror size and hinge thickness required to maintain adequate resonant frequencies, and reduces the amount of beam current required to deflect the micromirror. At high resolutions, the beam dwell time is very short so charge efficiency is very important. Underneath the mirror array, there is a transparent, equipotential layer that supports the array. The equipotential layer also shields the mirrors from accumulated static charge and prevents any attractive force from being developed that may otherwise cause the mirror to snap-over and become stuck to the substrate.

Unfortunately, MEMSolutions' CCM imager employs a collector grid, which is spaced apart from the insulating membrane opposite the micromirrors, to hold the grid potential. In this design, the distance between the collector grid and the insulating membrane strongly determines the collector grid potential that neutralizes the charge at the insulating membrane and micromirrors. The distance between the collector grid and insulating membrane is not, and can not be precisely controlled in mass productions, and causes the uncertainty of collector grid potential in different imagers. Thus will bring potential calibration problems during mass productions. Furthermore, MEMSolutions, Inc. used micromirrors made of matel, which potentially has flatness control problem and reliability problem.

### BRIEF SUMMARY OF THE INVENTION

In view of the above problems, the present invention provides a bright, low cost projection display.

The present invention uses Electron-beam Controlled Micromirror (ECM) display system (FIG. 1), which combines the advantages of DLP from TI and CCM from MEMSolutions, Inc.

### BRIEF DESCRIPTION OF THE SEVERAL VIEWS OF THE DRAWING

FIG. 1 is an illustration of ECM display system;

FIG. 2 is an illustration of an ECM imager;

FIG. 3 is diagram of the detailed structure of the micromirror device;

FIG. 4 is a diagram of the secondary-emission ratio (δ) vs. incident electron energy on dielectrics;

### DETAILED DESCRIPTION OF THE INVENTION

In following sections, we will discuss the ECM display system, the ECM imager, the micromirror device, and the operation of the ECM imager in details.

ECM Display System:

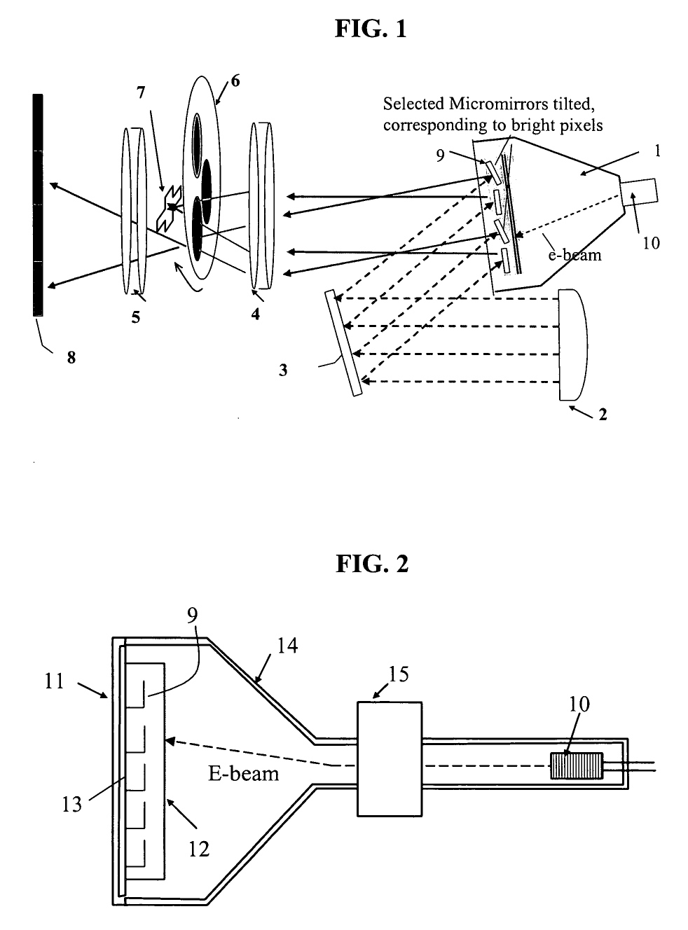

As shown in FIG. 1, the ECM display system consists of an ECM imager 1, a light source 2, a mirror 3, field lens 4, projection lens 5, a color wheel 6, a Schlieren stop 7, and a screen 8. During operation, a collimated light beam from light source 2 is directed towards an array of micromirrors 9 inside the ECM imager 1. The micromirrors response to a video addressing signal from the electron gun (e-gun) 10, imparts a modulation onto the light beam in proportion to the amplitude of the deflection of the individual micromirrors. The amplitude or phase modulated beam is then passed through Schlieren stop 7 and projection optics 5 to form the image. There is a mirror 3 in the light path between light source 2 and micromirror array 9, which could pass infrared component of the light and directs the collimated light to the ECM imager 1, thus prevents heating the micromirror array 9. A color display can be implemented by positioning a RGB (or Cyan and Magenta color, CMYK) wheel 6 in the light path to display by-pass RGB (or CMYK) monochrome image frame at a rate >25 frame/sec, which is commonly referred to as color sequential.

ECM Imager:

FIG. 2 shows the structure of an ECM imager 1. It consists of a face plate 11, an array of micromirrors 9, an insulation membrane with patterned grid 12, a glass substrate 13, a vacuum envelop 14, a yoke 15, and an e-gun 10. The electron beam addressing is similar to the technique used in CRTs. The e-gun mounted inside a funnel shaped glass vacuum envelop 14 produces an intensity-modulated e-beam. The yoke deflects the beam in a regular zigzag fashion, impinging each point on the ECM membrane 12.

The micromirror arrays 9 are fabricated using semiconductor compatible thin-film process. The array and vacuum cell are bonded together under vacuum.

Micromirror Device:

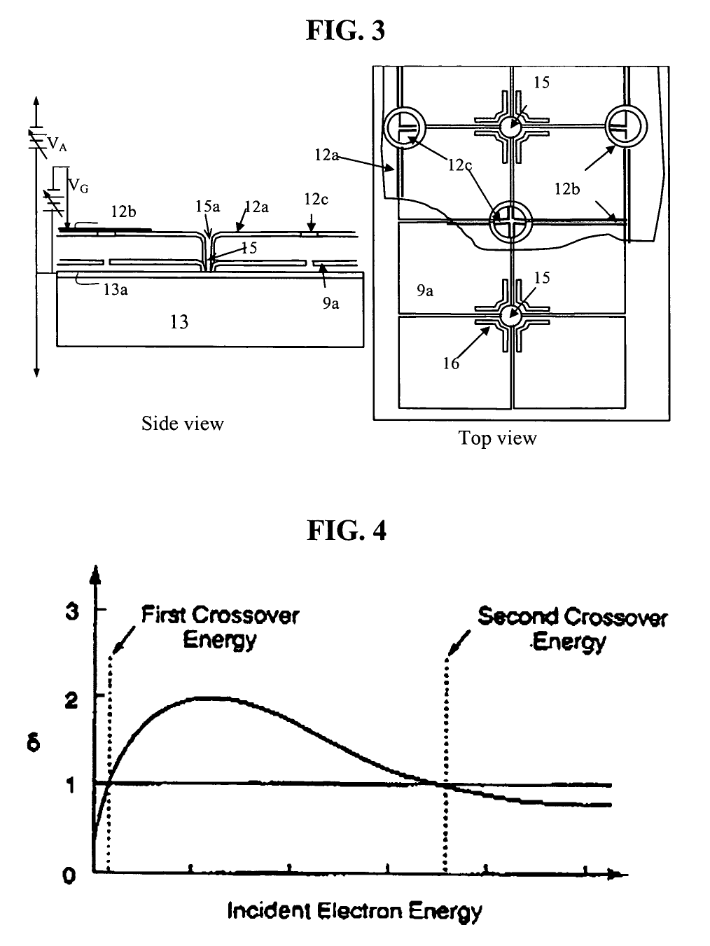

As shown in FIG. 3, the micromirror device consists of five layers, i.e., a glass substrate 13, a transparent conducting film 13a micromirrors 9a, an insulation membrane 12a, and a patterned collector grid 12b that is attached on the membrane 12a. The size of the micromirror array is ˜36×29 mm. The resolution of the imager is 1280×1024 or higher, corresponding to the number of micromirrors of each array.

As shown in FIG. 3, the mirror layer is patterned in a cloverleaf array of four centrally joined mirrors 9a that share a common post 15. Each mirror 9a is also patterned to a torsional flexion hinge 16, which gives higher compliance for a given fill factor. The mirrors and hinges 16 can be made extremely thin, e.g., 2000-3000 Å of metal or other materials, e.g., metal-ceramic-metal (MCM) “sandwich”. The advantage of MCM sandwich is that it provides better and repeatable flatness during fabrication, and mechanical stability during usage.

The membrane 12a is mounted on the substrate 13, 13a using posts 15a that share the same regions of mirror's common posts 15. The membrane has a number of vent holes 12c that are spaced between cloverleaf arrays and used for release the micromirrors 9a and membrane 12 during processing.

The usage of a thin insulating membrane 12a between micromirrors 9a and the electron gun 10 overcome problems of limited deflection range, high beam currents, eletrostatic instability and limited resolution associated with known electrostatically-actuated imagers. During operation, the incident electrons eject a number of secondary electrons from membrane that are collected by a positively biased collector grid 12b. The net charge pattern on the membrane modulates the potential difference between each of the micromirrors 9a and the membrane 12a, and produces an electrostatic force that deflects the micromirrors 9a. The number of electrons that address any particular localized region on the membrane 12a above the micromirror cells in the array determines the deflection angle and thus the amount of the light incident on that mirror 9a will be reflected for projection to the viewing screen 8.

In practice, the membrane 12a must be thick enough to stop the incident electrons from penetrating through to the micromirrors 9a and resilient enough to resist being torn off the post array 15. However, a thin membrane 12a is desirable to improve charge efficiency and maintain resolution as well as for cost and fabrication reasons.

The transparent substrate 13 and the imager's faceplate 11 can be the same panel. In this case, its thickness must provide enough strength to hold off atmospheric pressure, e.g., 3-5 mm.

Operation of the ECM Imager:

The operation of the ECM imager 1 are similar to a traditional CRT. An electron gun 10 is used to write a charge pattern onto the membrane 12a over the mirrors 9a. The same e-gun 10 may be used to charge or discharge the membrane. The e-gun emits electrons that are accelerated by the anode potential V_{A} (FIG. 3) and strike the backside of the membrane 12a, causing secondary electrons to be ejected and collected by the collector grid 12b.

FIG. 4 shows a typical graph of the secondary-emission ratio (δ) vs. incident electron energy of a dielectric material. The secondary-emission ratio is the ratio of the number of electrons emitted to the number of electrons incident on a surface. Both writing and erasing should be accomplished with electron-beam energies near the second crossover (where δ=1) for high performance and long-term stability. In this region the membrane 12a can be charged positive by operating lower than the crossover (δ>1). A negative charge can be achieved by operating just above the crossover (δ<1). Positive charging is enhanced by a field that directs secondary electrons away from the membrane 12a, whereas negative charging occurs with a field that redirects secondary electrons back to the surface. Below first crossover and above second crossover, only negative charging is possible.

The continuous image is achieved by performing write and erase cycles repeatedly. During the write cycle, the modulated e-beam scans the membrane 12a and the collector 12b bias is switched positive to create a secondary electron collecting field at the membrane 12a surface. Since more electrons leave than land (δ>1), the net charge on the membrane 12a becomes positive. The deposition of the charge pattern onto the membrane 12a increases the electric field between the membrane 12a and the substrate conducting layer 13a, and produces attractive forces that tend to deflect the mirrors 9a towards the membrane 12a (since the mirror 9a potential or V_{A} is set to ground). The attractive force is opposed by the mirror's hinge 16 stress and the amount of deflection is determined by the force rebalance equation for a given geometry. The mirror 9a deflection in turn imparts a modulation onto a beam of light. When the beam is accurately registered to the rows or columns of mirror elements, clearly defined single rows or columns of elements will be observed written on the screen. In general, the more deposited charge, the stronger the electric field and the larger the deflection will be.

To erase the image, the electrostatic force on the mirrors 9a must be reduced to zero. This requires that the deposited charge on the membrane 12a is neutralized. One way of doing this is to increase the beam acceleration voltage to a level higher than the secondary emission crossover and then re-scan the membrane 12a with the same beam modulation. For example with the image written below the second crossover (but still >the first crossover), the membrane is charged positive. To erase the charged pattern, the gun voltage is then increased above the second crossover (where δ<1) so that (δ_{write}−1)≈−(δₑᵣₐₛₑ−1), and the same image is scanned into the membrane 12a, with negative charge. In this case, the erase scan neutralizes previous positive charge on membrane 12a. Simultaneously, grid 12b potential V_{G} should be changed to equal to anode potential V_{A}, thus, the mirror is brought to equilibrium with both electrodes (V_{A} and V_{G}) and consequently the electrostatic bias disappears. At this point, all of the mirrors 9a have the same potential and are at their neutral positions.

We claim:

1. A projection display, comprising:
a light source that emits collimated light;
a reflective imager that angularly modulates the collimated light, said angularly modulated light being turned back through a field lens and focused onto a Schlieren stop plane, said imager comprising
a vacuum envelope;
a electron-beam controlled mirror (ECM) array mounted in said vacuum envelope, comprising,
a transparent substrate;
a transparent, electro-conductive layer on said transparent substrate; a conductive micro-mirror array integrated onto and in electrical contact with said electro-conductive layer that are all held at a reference potential;
a floating-potential dielectric membrane supported by an array of insulating posts above said array of micro-mirrors; and
a focusable electron source that emits primary electrons that are accelerated and strike portions of said dielectric membrane above the respective micro-mirrors causing a fixed charge pattern on said membrane; and
a field lens that focuses the collimated light component from said ECM array onto said Schlieren stop plane; and
a Schlieren stop at said Schlieren stop plane that converts the angularly modulated light into intensity modulated light; and
a projection lens that focuses the intensity modulated light onto a viewing screen to form an image.

2. The projection display of claim 1, wherein said transparent, electro-conductive layer is an aperture patterned conducting plane.

3. The projection display of claim 1, wherein said floating-potential dielectric membrane is a semiconducting membrane.

4. The projection display of claim 1, wherein a conductive collector grid array is attached on said dielectric membrane such that it can be held at a collector potential with respect to the mirror voltage.

5. The projection display of claim 1, further comprising a color wheel such that the display of color image video is carried out by continuously displaying multiple mono-color images in a temporally multiplexed fashion.

6. The projection display of claim 1, wherein said light is split into a plurality of color components, said projection display comprising the same plurality of said reflective imagers that spatially modulate the respective color components.

7. The projection display of claim 1, wherein said imager further comprises an array of attractor pads on said electron source side of said membrane that are aligned with said micro-mirror array, said source writing charge pattern onto said attractor pads such that each micro-mirror's charge is distributed approximately uniformly across the corresponding attractor pad.

8. The projection display of claim 1, wherein said light source emits infrared components of light for producing infrared image on said screen.

9. The projection display of claim 1, wherein said light source emits ultraviolet components of light for producing ultraviolet image on said screen.

10. The projection display of claim 1, wherein said micromirror array is configured with cloverleaf arrays of four centrally joined cantilever beams that share common post regions on said electro-conductive layer.

11. The projection display of claim 1, wherein said micromirror array is made of metal.

12. The projection display of claim 1, wherein said micromirror array is made of dielectric material with both side covered with metal.

13. The projection display of claim 1, wherein said charge pattern increases the localized membrane potentials so that the potential differences between said membrane and said micromirrors produces the finely-defined attractive electrostatic forces.

14. The projection display of claim 4, wherein said charge pattern increases the localized membrane potentials so that the potential differences between said membrane and said micromirrors produces the finely-defined attractive electrostatic forces, said micromirrors being susceptible to snap-over when the potential difference exceeds a threshold potential, said collector grid being biased so that said grid potential is less than said threshold potential.

15. The projection display of claim 10, wherein said imager further comprising an attractor pad array on the backside of said membrane that are aligned with said cantilever beams.

16. The projection display of claim 15, wherein said attractor pad array includes one said attractor pad per cantilever beam.

17. The projection display of claim 10, wherein said insulating posts are on said substrate in said common posts regions and formed integrally with said membrane.
